(19) United States
(12) Patent Application Publication
(10) Pub. No.: US 2020/0033537 A1
(43) Pub. Date: Jan. 30, 2020

(54) ELECTRONIC DEVICE AND ASSEMBLY WHICH INCLUDES OPTICAL-WAVE GUIDES

(71) Applicant: STMicroelectronics (Grenoble 2) SAS, Grenoble (FR)

(72) Inventors: Romain COFFY, Voiron (FR); Florian PERMINJAT, Saint Romans (FR); Jean-Michel RIVIERE, Froges (FR)

(73) Assignee: STMicroelectronics (Grenoble 2) SAS, Grenoble (FR)

(21) Appl. No.: 16/519,753

(22) Filed: Jul. 23, 2019

(30) Foreign Application Priority Data
Jul. 25, 2018 (FR) 1856883

(51) Int. Cl. G02B 6/30

(52) U.S. Cl. CPC G02B 6/30

(57) ABSTRACT

An electronic chip includes an integrated optical-wave guide having an end section that extends parallel to a face of the electronic chip. A local groove provided in the electronic chip extends adjacent to the end section of the integrated optical-wave guide. An elongate optical cable includes an optical-wave guide and has an end portion that is at least partially engaged in the local groove. The end portion of the elongate optical cable is configured to support an optical coupling of the optical-wave guide to the integrated optical-wave guide via lateral coupling in a zone of the local groove. An exterior package is provided to house the electronic chip.

### PRIORITY CLAIM

This application claims the priority benefit of French Application for Patent No. 1856883, filed on Jul. 25, 2018, the content of which is hereby incorporated by reference in its entirety to the maximum extent allowable by law.

### TECHNICAL FIELD

The present invention relates to the field of electronic devices and assemblies including optical-wave guides.

### SUMMARY

According to one embodiment, an electronic device is provided that comprises an electronic chip including at least one integrated optical-wave guide having an end section that extends parallel to a face of the chip and in a specific direction and provided with a local groove adjacent to said end section of the optical-wave guide and extending in said specific direction.

The electronic device furthermore comprises an elongate optical cable including at least one optical-wave guide and having an end portion that is at least partially engaged in said local groove and that extends parallel to said specific direction, in a position such that the optical-wave guide of the optical cable is optically coupled to the optical-wave guide of the chip, via lateral coupling in the zone of said local groove.

Thus, the mounting of the optical cable on the chip is mechanically very strong and the bulk of the electronic device in the direction of the thickness of the chip is small.

The optical cable may be fastened to the chip by way of an adhesive layer that is interposed between the chip and the end section of the optical cable.

The electronic device may comprise a holding element mounted above the chip and the end section of the optical cable.

Said holding element may comprise a groove in which the end section of the optical cable is at least partially engaged.

An adhesive layer may be interposed between the holding element and the end section of the optical cable.

The chip may comprise a base wafer including said integrated optical-wave guide and a front layer including a network of electrical connections, said groove being produced in this front layer.

The device may comprise a substrate facing the chip and extending above said end portion of the optical cable, opposite said groove of the chip.

Said substrate may have a groove in which the end section of the optical cable is at least partially engaged.

An adhesive layer may be interposed between the substrate and the end section of the optical cable.

Said substrate may include a network of electrical connections, electrical connection elements being interposed between the chip and the substrate.

The optical-light-wave guide of the optical cable may include an integrated longitudinal core and, in a terminal module, an integrated core one end of which is joined axially to the corresponding end of the longitudinal core and the other end or an end section of which lies flush with a side of the module located on the side of the end section of the optical-wave guide of the chip.

An assembly is also provided that comprises an electronic device such as defined above and that comprises an exterior package inside which the electronic device is housed.

The optical cable may comprise an optical connector mounted on a wall of the package so as to allow one or more exterior optical connections of the electrical device through this wall.

The assembly may comprise an electrical connection cable provided at one end with an electrical connector that is connected to the electrical device and at its other end with an electrical connector that is mounted on a side wall of the package, so as to allow one or more exterior electrical connections of the electrical device through this wall.

### BRIEF DESCRIPTION OF THE DRAWINGS

An electronic device and an assembly will now be described by way of non-limiting example, illustrated by the drawing in which:

FIG. 1 shows a longitudinal cross section of an electronic device, longitudinally to an optical cable;

FIG. 2 shows a transverse cross section of the electronic device of FIG. 1, transversely to an end portion of the optical cable; and

FIG. 3 shows a longitudinal cross section of an assembly including the electronic device of FIG. 1.

### DETAILED DESCRIPTION

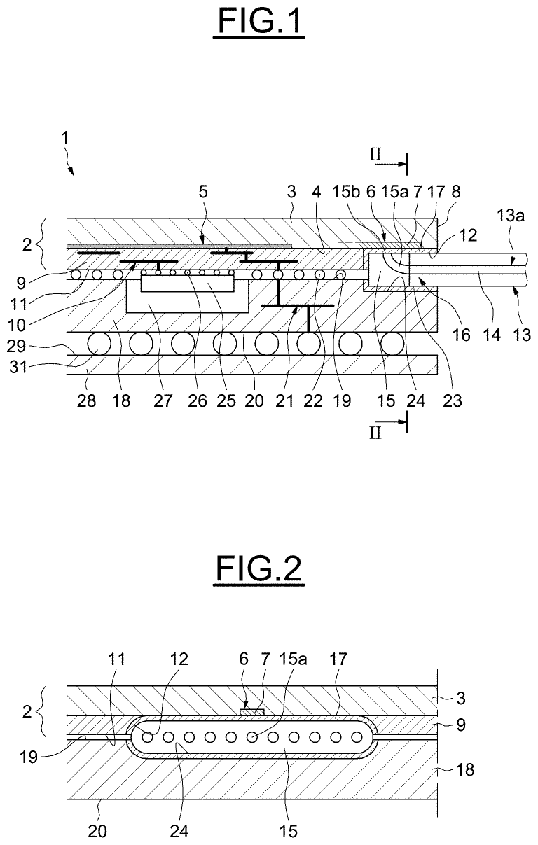

An electronic device 1 illustrated in FIGS. 1 and 2 comprises an electronic integrated circuit chip 2 that comprises a base wafer 3, for example made of semiconductor material such as silicon. On the side of a front face 4 of the base wafer 3 there are provided: integrated electronic components 5 and an integrated guide 6 of optical or light waves. The optical-wave guide 6 has an, advantageously rectilinear, end section 7 that is adjacent to the front face 4. The end section 7 is advantageously located in a zone close to one side (peripheral edge) 8 of the chip 2 and for example extends perpendicularly to this side 8, in what is called a longitudinal direction, the side 8 extending in a perpendicular direction.

The electronic chip 2 comprises a front layer 9 formed above the front face 4 and provided with an integrated network 10 of electrical connections for connecting the electronic components 5 to front electrical-connection pads of a front face 11 of the front layer 9.

The optical waveguide 6 is connected to at least some of the electronic components 5 so that signals transported by the input optical waves are converted into electrical signals and/or so that electrical signals output from at least some of the electronic components 5 are converted into optical signals transported by output optical waves.

In the front layer 9 of the chip 2 is produced a local groove 12 that is located above the zone in which is located the end section 7 of the optical waveguide 6 and adjacent to the end section 7. The groove extends depthwise as far as to the face 4 of the base wafer 3. The local groove 12 extends, in the longitudinal direction, parallel to the face 4 of the base wafer 3 and parallel to the terminal section 7 of the optical waveguide 6 of the chip 2. The local groove 12 advantageously extends from the lateral edge 8 of the chip 2 and perpendicularly to this lateral edge 8.

The electronic device 1 further comprises a, generally flexible, elongate optical-connection cable 13 that comprises an optical-light-wave guide 13a that includes an integrated longitudinal core 14 and, in a terminal module 15, an integrated core 15a one end of which is axially joined to the corresponding end of the core 14 and the other end or an end section of which lies flush with a side 15b of the module 15 located on the side of the bottom of the local groove 12, i.e. on the side of the end section 7 of the optical-wave guide 6 of the chip 2. The core 15a of the terminal module 15 may be made of a polymer.

An end portion 16 of the optical cable 13, including at least partially the terminal module 15, is engaged flat and fastened in the local groove 12. The end portion 16 of the optical cable 13 extends parallel to the front faces 4 and/or 9, to the bottom of the local groove 12 and to the opposite flanks of this groove 12, in the aforementioned longitudinal direction of the groove 12. The optical-wave guide 13a of the optical cable 13 is optically coupled, via the terminal module 15, to the end section 7 of the optical waveguide 6 of the chip 2, via lateral coupling in the zone of the local groove 12.

The end portion 16 of the optical cable 13 is fastened in the local groove 12 by way of an adhesive layer 17 made of a material able to be passed through by (e.g., transparent to) the optical waves.

According to one variant embodiment, the chip 2 includes a plurality of integrated optical-wave guides 6, having end sections 7 that are parallel and neighboring to each other and connected to the electronic components 5. The optical cable 13 includes a corresponding plurality of optical waveguides 13a, including cores 14 and 15a, placed parallel in the form of a ribbon. The end portion 16 of the optical cable 13 is then engaged flat in a corresponding groove 12. The optical-wave guides 13a of the optical cable 13 are optically coupled, via the terminal module 15, to the terminal sections 7 of the optical-wave guides 6 of the chip 2, via lateral coupling, respectively.

The electronic device 1 furthermore comprises a substrate 18 that is located in front of the front face 11 of the electronic chip 2 and that has a back face 19 facing the front face 11 and a front face 20. The substrate 18 includes an integrated network 21 of electrical connections of one face to the other.

The network 10 of electrical connections of the chip 2 is connected to the network 21 of electrical connections of the substrate 18 for example by way of electrical connection elements 22 that are interposed between pads of the front face 11 and pads of the back face 19.

The substrate 18 extends above the end portion 16 of the optical cable 13, opposite the groove 12, so as to contribute to holding this end portion 16.

Between the end portion 16 of the optical cable 13 and the substrate 18 is interposed an adhesive layer 23.

In the case where the protruding portion of the end portion 16 of the optical cable 13 has a thickness larger than the separation between the chip 2 and the substrate 18, the substrate 18 is provided with a local groove 24 in which this protruding portion is engaged, the adhesive layer 23 being interposed between the end portion 16 of the optical cable 13 and the local groove 24.

As a result of the above, the end section 16 of the optical cable 13 is sandwiched (i.e., clamped) between the chip 2 and the substrate 18, so that the end section 16 is securely fastened to the chip 2.

The electronic device 1 furthermore comprises an additional integrated circuit chip 25 that is located above the front face 11 of the chip 2, in a zone exempt of electrical connection elements 22, and that is connected to the network 10 of electrical connections of the chip 2 by way of electrical connection elements 26 that are interposed between pads of the front face of the chip 2 and pads of the additional chip 25.

The substrate 18 is provided with a local void 27 within which the additional chip 25 is located, but not constrained. According to one variant embodiment, not explicitly shown, the local void 27 may completely pass through the substrate 18.

The electronic device 1 also comprises a printed circuit board 28, a face 29 of which is located facing the face 20 of the substrate 18, wherein the board 28 is provided with a printed circuit 30. Electrical connection pads of the network 21 of electrical connections of the substrate 18 are connected to the printed circuit 30 by electrical connection elements 31 that are interposed between the faces 20 and 29.

According to one variant embodiment (not shown), the substrate 18 leaves a free space above a zone of the chip 2 including the end portion 16 of the optical cable 13 and the end portion 16 of the optical cable 13 is held by a holding element, which is independent of the substrate 18, fastened above the face 11 of the chip 2 and which passes above the end portion 16 of the optical cable 13. An adhesive layer may be interposed between this holding element and the end portion 16 of the optical cable 13.

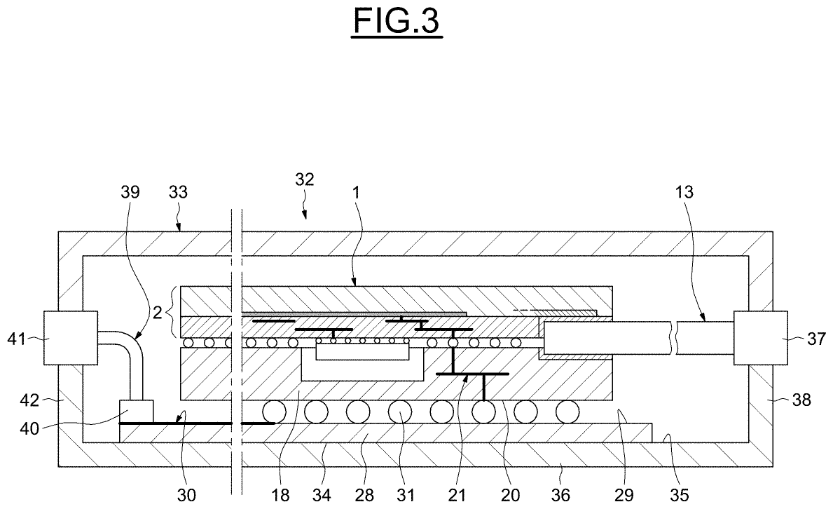

As illustrated in FIG. 3, an assembly 32 comprises the electronic device 1 and an exterior encapsulating package 33 inside which the electronic device 1 is housed.

That face 34 of the printed circuit board 28 which is opposite its face 29 is fastened above an interior face 35 of a base wall 36 of the package 33 for example by an adhesive layer.

The optical cable 13 is provided, at its other end, with an optical connector 37 that is fastened to a side wall 38 of the package 33, so as to allow one or more exterior optical connections of the electrical device 1 through this wall 38.

A, generally flexible, elongate electrical connection cable 39 is provided at one end with an electrical connector 40 mounted above the face 29 of the printed circuit board 28, on a portion extending beyond an edge of the chip 2, and connected to the printed circuit 30 and at its other end with an electrical connector 41 that is mounted on a side wall 42 of the package 33, so as to allow one or more exterior electrical connections of the electrical device 1 through this wall 42.

1. An electronic device, comprising:
an electronic integrated circuit chip including a semiconductor wafer and a front interconnect layer, wherein at least one integrated optical-wave guide in the semiconductor wafer has an end section that extends parallel to a face of the semiconductor wafer in a longitudinal direction and wherein the front interconnect layer includes a local groove adjacent to said end section of the at least one integrated optical-wave guide and extending in said longitudinal direction, and
an elongate optical cable including at least one optical-wave guide and having an end portion that is at least partially engaged in said local groove and that extends parallel to said longitudinal direction, in a position such that the at least one optical-wave guide of the optical cable is optically coupled to the at least one integrated optical-wave guide in the semiconductor wafer via a lateral coupling in a zone of said local groove;
wherein the optical-light-wave guide of the elongate optical cable includes an integrated longitudinal core; and
wherein a terminal module of the optical-light-wave guide of the elongate optical cable includes an integrated core having one end that is axially joined to a corresponding end of the integrated longitudinal core and having another end which lies flush with a side of the terminal module located adjacent to the end section of the at least one integrated optical-wave guide.

2. The device according to claim 1, wherein an adhesive layer is interposed between the semiconductor wafer and the end portion of the elongate optical cable.

3. The device according to claim 1, further comprising a holding element mounted above the electronic integrated circuit chip and the end portion of the elongate optical cable.

4. The device according to claim 3, wherein said holding element comprises a further local groove in which the end portion of the optical cable is at least partially engaged.

5. The device according to claim 3, wherein an adhesive layer is interposed between the holding element and the end portion of the elongate optical cable.

6. The device according to claim 1, wherein the semiconductor wafer includes a peripheral edge extending perpendicular to the longitudinal direction.

7. The device according to claim 1, further comprising a substrate facing the electronic integrated circuit chip and extending above said end portion of the elongate optical cable, opposite said local groove.

8. The device according to claim 7, wherein the substrate has a further local groove in which the end portion of the elongate optical cable is at least partially engaged.

9. The device according to claim 7, wherein an adhesive layer is interposed between the substrate and the end portion of the elongate optical cable.

10. The device according to claim 7, wherein the substrate includes a network of electrical connections, and further comprising electrical connection elements interposed between the front interconnect layer of the electronic integrated circuit chip and the substrate.

11. The device according to claim 1, wherein the integrated core of the terminal module make a ninety-degree bend between said one end and said another end.

12. An assembly, comprising:
an electronic device including:
an electronic integrated circuit chip including a semiconductor wafer and a front interconnect layer, wherein at least one integrated optical-wave guide in the semiconductor wafer has an end section that extends parallel to a face of the semiconductor wafer in a longitudinal direction and wherein the front interconnect layer includes a local groove adjacent to said end section of the at least one integrated optical-wave guide and extending in said longitudinal direction, and
an elongate optical cable including at least one optical-wave guide and having an end portion that is at least partially engaged in said local groove and that extends parallel to said longitudinal direction, in a position such that the at least one optical-wave guide of the optical cable is optically coupled to the at least one integrated optical-wave guide in the semiconductor wafer via a lateral coupling in a zone of said local groove; and
an external package inside of which the electronic device is housed;
wherein the optical-light-wave guide of the elongate optical cable includes an integrated longitudinal core; and
wherein a terminal module of the optical-light-wave guide of the elongate optical cable includes an integrated core having one end that is axially joined to a corresponding end of the integrated longitudinal core and having another end which lies flush with a side of the terminal module located adjacent to the end section of the at least one integrated optical-wave guide.

13. The assembly according to claim 12, where in the elongate optical cable comprises an optical connector mounted on a wall of the external package so as to allow one or more exterior optical connections of the electrical device through the wall.

14. The assembly according to claim 12, further comprising an electrical connection cable provided at one end with an electrical connector that is connected to the electrical device and at another end with an electrical connector that is mounted on a wall of the external package, so as to allow one or more exterior electrical connections of the electrical device through the wall.

15. The assembly according to claim 12, wherein an adhesive layer is interposed between the semiconductor wafer and the end portion of the elongate optical cable.

16. The assembly according to claim 12, further comprising a holding element mounted above the electronic integrated circuit chip and the end portion of the elongate optical cable.

17. The assembly according to claim 16, wherein said holding element comprises a further local groove in which the end portion of the optical cable is at least partially engaged.

18. The assembly according to claim 16, wherein an adhesive layer is interposed between the holding element and the end portion of the elongate optical cable.

19. The device according to claim 12, wherein the integrated core of the terminal module make a ninety-degree bend between said one end and said another end.
